(19) United States
(12) Patent Application Publication
(10) Pub. No.: US 2020/0371449 A1
(43) Pub. Date: Nov. 26, 2020

(54) CONDUCTIVE ROLLER FOR ELECTROPHOTOGRAPHIC DEVICE

(71) Applicant: Sumitomo Riko Company Limited, Aichi (JP)

(72) Inventors: Takeru HORIUCHI, Aichi (JP); Yosuke HAYASHI, Aichi (JP); Yasunori NIMURA, Aichi (JP); Shinkichi KASHIHARA, Aichi (JP); Kenta NAKAZATO, Aichi (JP)

(73) Assignee: Sumitomo Riko Company Limited, Aichi (JP)

(21) Appl. No.: 16/988,735

(22) Filed: Aug. 10, 2020

Related U.S. Application Data
(63) Continuation of application No. PCT/JP2019/020850, filed on May 27, 2019.

(30) Foreign Application Priority Data
Jul. 30, 2018 (JP) 2018-142020

(51) Int. Cl. G03G 15/02; C09C 1/48

(52) U.S. Cl. CPC G03G 15/0233; C09C 1/48

(57) ABSTRACT

A conductive roller for electrophotographic device is provided, in which the agglomeration of carbon black to be blended is suppressed and the surface layer of the conductive roller has excellent resistance uniformity when a water-based coating is used. The conductive roller for electrophotographic device 10 including a shaft body 12, an elastic body layer 14 formed on the outer periphery of the shaft body 12, and a surface layer 16 formed on the outer periphery of the elastic body layer 14, and the surface layer 16 is formed from an emulsion composition containing the following (a) to (d): (a) an aqueous polyurethane resin, (b) a urethane curing agent, (c) an associative thickener, and (d) carbon black.

### CROSS-REFERENCE TO RELATED APPLICATION

This application is a continuation application of International Application number PCT/JP2019/020850 on May 27, 2019, which claims the priority benefit of Japan Patent Application No. 2018-142020, filed on Jul. 30, 2018. The entirety of each of the above-mentioned patent applications is hereby incorporated by reference herein and made a part of this specification.

### BACKGROUND

### Technical Field

The present disclosure relates to a conductive roller for electrophotographic device suitably used in an electrophotographic device such as a copier, a printer, or a facsimile which employs electrophotography.

### Related Art

In the electrophotographic device such as a copier, a printer, or a facsimile which employs electrophotography, a conductive roller such as a charging roller, a developing roller, a transfer roller, and a toner supply roller is arranged around a photosensitive drum. A conductive roller is known which has a conductive elastic body layer on the outer periphery of a shaft body made of core metal and has a surface layer on the outer periphery of the elastic body layer. Carbon black for conductivity may be blended in the surface layer.

An organic coating containing an organic solvent is used as the surface layer formation material of the conductive roller. From the viewpoint of environment, attempts have been made to use a water-based coating instead of the organic coating. For example, patent literature 1 describes that the surface layer of the conductive roller is formed using a water-based coating with which the glass transition temperature of the surface layer is 45° C. or higher.

### LITERATURE OF RELATED ART

### Patent Literature

Patent literature 1: Japanese Patent Laid-Open No. 2011-022286

The water-based coating has a slower drying rate than that of the organic coating. Therefore, when a water-based coating is used as the surface layer formation material of the conductive roller, the carbon black which is blended for conductivity may agglomerate in the period from application to drying, and the resistance uniformity of the surface layer may deteriorate.

The problem to be solved by the present disclosure is to provide a conductive roller for electrophotographic device in which agglomeration of carbon black to be blended is suppressed and the surface layer has excellent resistance uniformity when a water-based coating is used.

### SUMMARY

In order to solve the above problem, a conductive roller for electrophotographic device according to the present disclosure includes a shaft body, an elastic body layer formed on the outer periphery of the shaft body, and a surface layer formed on the outer periphery of the elastic body layer, the surface layer being formed from an emulsion composition containing the following (a) to (d):
(a) an aqueous polyurethane resin,
(b) a urethane curing agent,
(c) an associative thickener, and
(d) carbon black.

In one of the exemplary embodiments, (a) has an anionic hydrophilic group. In one of the exemplary embodiments, (b) is a terminal isocyanate-modified polyurethane and has an anionic hydrophilic group. In one of the exemplary embodiments, (d) has an anionic surface functional group. In one of the exemplary embodiments, (c) is a nonionic thickener having a hydrophobic group and a nonionic hydrophilic group. In one of the exemplary embodiments, the terminal isocyanate group of (b) is a blocked isocyanate group blocked with a blocking agent. In one of the exemplary embodiments, the anionic hydrophilic group is a carboxylate group and the carboxylate group forms an amine salt. In one of the exemplary embodiments, the emulsion composition further contains (e) a fluorine-based surface modifier. In one of the exemplary embodiments, (e) has a benzyl group and an amino group. In one of the exemplary embodiments, the emulsion composition further contains (f) silica particles, and (f) is spherical silica having a diameter of 500 nm or less in one of the exemplary embodiments.

The method of manufacturing a conductive roller for electrophotographic device according to the present disclosure is a method of manufacturing a conductive roller for electrophotographic device which includes a shaft body, an elastic body layer formed on the outer periphery of the shaft body, and a surface layer formed on the outer periphery of the elastic body layer. The method includes forming the surface layer using an emulsion composition containing the following (a) to (d):
(a) an aqueous polyurethane resin,
(b) a urethane curing agent,
(c) an associative thickener, and
(d) carbon black.

### BRIEF DESCRIPTION OF THE DRAWINGS

According to the conductive roller for electrophotographic device of the present disclosure, because the surface layer is formed from the emulsion composition containing the above (a) to (d), the agglomeration of the blended carbon black is suppressed, and the surface layer has excellent resistance uniformity.

At this time, when (a) has an anionic hydrophilic group, the self-emulsifying power is high and (a) in the emulsion composition has excellent dispersion stability. In addition, because a self-emulsifying urethane emulsion is formed, it is not necessary to use a surfactant for emulsification, and the deterioration of physical properties caused by bleeding of the surfactant is suppressed in the surface layer. In addition, when (b) is a terminal isocyanate-modified polyurethane and has an anionic hydrophilic group, the self-emulsifying power is high and (b) in the emulsion composition has excellent dispersion stability. In addition, when (d) has an anionic surface functional group, (d) in the emulsion composition has excellent dispersion stability.

Besides, when (c) is a nonionic thickener having a hydrophobic group and a nonionic hydrophilic group, the electrostatic action of (c) is small, and thus the reduction in dispersibility of (d) in the emulsion composition caused by the electrostatic action of (c) is suppressed. In addition, when (a) or (b) has an anionic hydrophilic group, the gelation caused by the ionic interaction between (a) and (c) or the ionic interaction between (b) and (c) is suppressed.

Besides, when the terminal isocyanate group of (b) is a blocked isocyanate group blocked with a blocking agent, the emulsion composition has excellent stability. In addition, in the blocked isocyanate, the blocking agent is desorbed by heating to a predetermined temperature and an active isocyanate group is formed. Therefore, in the emulsion composition, it is possible to slow down the curing of (a) caused by (b). Then, when the emulsion composition contains (e) the fluorine-based surface modifier, it is possible to suppress the curing of (a) caused by (b) after application of the emulsion composition and before (e) bleeds on the surface, and it is possible to contribute to sufficient performance of properties of (e).

Besides, when the anionic hydrophilic group is a carboxylate group and the carboxylate group forms an amine salt, the self-emulsifying power is high, and (a) in the emulsion composition has excellent dispersion stability. In addition, the hydrophilicity of a dry film is reduced due to volatilization of the amine during drying, and thus the surface layer has excellent water resistance. That is, the dispersion stability and the water resistance when a water-based coating is used can be highly compatible.

Besides, when the emulsion composition further contains (e) the fluorine-based surface modifier, the roll surface has excellent antifouling property, and the effect of suppressing adhesion of toner, an external toner additive and the like is improved. At this time, when (e) has a carboxy group and an amino group, the resistance uniformity is improved.

Then, when the emulsion composition further contains (f) silica particles and (f) is spherical silica having a diameter of 500 nm or less, the resistance uniformity is improved.

Besides, according to the method of manufacturing a conductive roller for electrophotographic device of the present disclosure, because the surface layer is formed using the emulsion composition containing the above (a) to (d), the agglomeration of the blended carbon black is suppressed, and the surface layer has excellent resistance uniformity.

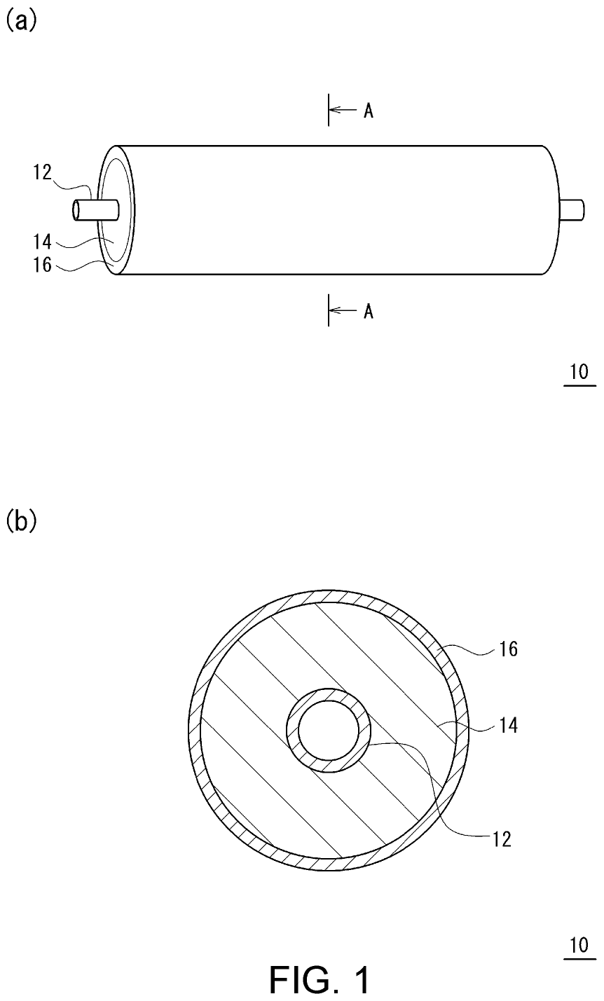

(a) of FIG. 1 is a schematic external view of a conductive roller for electrophotographic device according to an embodiment of the present disclosure, and (b) of FIG. 1 is a cross-sectional view taken along line A-A of the conductive roller for electrophotographic device.

### DESCRIPTION OF THE EMBODIMENTS

A conductive roller for electrophotographic device according to the present disclosure (hereinafter, simply referred to as conductive roller sometimes) is described in detail. (a) of FIG. 1 is a schematic external view of the conductive roller for electrophotographic device according to an embodiment of the present disclosure, and (b) of FIG. 1 is a cross-sectional view taken along line A-A of the conductive roller for electrophotographic device.

A conductive roller 10 includes a shaft body 12, an elastic body layer 14 formed on the outer periphery of the shaft body 12, and a surface layer 16 formed on the outer periphery of the elastic body layer 14. The elastic body layer 14 is a layer (base layer) serving as a base for the conductive roller 10. The surface layer 16 serves as a layer that appears on the surface of the conductive roller 10. In addition, although not particularly shown, an intermediate layer such as a resistance adjustment layer may be formed between the elastic body layer 14 and the surface layer 16 if necessary.

The surface layer 16 is formed from an emulsion composition containing the following (a) to (d):
(a) an aqueous polyurethane resin,
(b) a urethane curing agent,
(c) an associative thickener, and
(d) carbon black.

(a) is an aqueous polyurethane resin. The aqueous polyurethane resin is obtained by improving the hydrophilicity with various methods and performing water dispersion. Depending on the method of water dispersion, the aqueous polyurethane resin includes forced-emulsifying resins in which a surfactant is used as an emulsifier and self-emulsifying resins in which a hydrophilic group is introduced into the polyurethane resin. Because the self-emulsifying resins do not require the use of the surfactant for emulsification, the deterioration of physical properties caused by bleeding of the surfactant is suppressed in the surface layer 16.

In the self-emulsifying aqueous polyurethane resin, the hydrophilic group introduced into the polyurethane resin may be a nonionic hydrophilic group or an ionic hydrophilic group (anionic hydrophilic group, cationic hydrophilic group). In particular, the ionic hydrophilic group is preferable. The polyurethane resin having an ionic hydrophilic group has high self-emulsifying power, and (a) in the emulsion composition has excellent dispersion stability. Among the ionic hydrophilic groups, the anionic hydrophilic group is more preferable. Because the anionic hydrophilic group can form an amine salt and the hydrophilicity of a dry film is reduced due to volatilization of the amine during drying, the surface layer 16 has excellent water resistance.

The anionic hydrophilic group may be a carboxylate group (—COO—), a sulfonic group (—SO₃—), and the like. The cationic hydrophilic group may be a quaternary ammonium group and the like. The nonionic hydrophilic group may be a polyoxyalkylene group and the like. Among the anionic hydrophilic groups, the carboxylate group is more preferable. Because the amine salt is easily formed and the hydrophilicity of the dry film is reduced due to the volatilization of the amine during drying, the surface layer 16 has excellent water resistance. Besides, when the anionic hydrophilic group is a carboxylate group and the carboxylate group forms an amine salt, the self-emulsifying power is high, and (a) in the emulsion composition has excellent dispersion stability. In addition, because the hydrophilicity of the dry film is reduced due to the volatilization of the amine during drying, the surface layer 16 has excellent water resistance. That is, the dispersion stability and the water resistance when a water-based coating is used can be highly compatible.

The polyurethane resin is a reaction product of polyisocyanate and polyol and includes a soft segment composed of a polyol component having a weak agglomeration force and a hard segment composed of urethane bonds having a strong agglomeration force. The forced-emulsifying aqueous polyurethane resin is composed of, for example, a polyisocyanate component and a polyol component. The self-emulsifying aqueous polyurethane resin is composed of, for example, a polyisocyanate component, a polyol component, and a hydrophilic group-containing component.

The polyisocyanate used for forming the aqueous polyurethane resin may be: diphenyl methane diisocyanate (MDI), polymethylene polyphenylene polyisocyanate (polymeric MDI), crude MDI (c-MDI) that is a mixture of MDI or polymeric MDI, dicyclohexyl methane diisocyanate (hydrogenated MDI), tolylene diisocyanate (TDI), hexamethylene diisocyanate (HDI), trimethyl hexamethylene diisocyanate (TMHDI), isophorone diisocyanate (IPDI), orthotoluidine diisocyanate (TODI), naphthylene diisocyanate (NDI), xylylene diisocyanate (XDI), paraphenylene diisocyanate (PDI), lysine diisocyanate methyl ester (LDI), dimethyl diisocyanate (DDI), MDI nurate, HDI nurate, and TDI nurate that are multimers, modified bodies obtained by making the above polyisocyanate into urea compound, biuret, allophanate, carbodiimide, urethane or the like. These polyisocyanate may be used alone as the polyisocyanate of the aqueous polyurethane resin, or two or more types of the polyisocyanate may be used in combination. From the viewpoint of preventing coloration, the polyisocyanate of the aqueous polyurethane resin is preferably an aliphatic polyisocyanate (non-yellowing polyisocyanate).

As the polyisocyanate used for forming the aqueous polyurethane resin, a NCO-terminal urethane prepolymer obtained by causing the polyisocyanate such as MDI to react with polyol may be used. Because the urethane prepolymer used as the polyisocyanate has the NCO-terminal, the NCO % is preferably 5 to 30 mass %. The NCO % is calculated by the following expression.

$$NCO \% = \frac{\begin{matrix}\frac{weight of polyisocyanate}{equivalent weight of polyisocyanate} - \\ \frac{weight of polyol}{equivalent weight of polyol} \times 42.02\end{matrix}}{weight of polyisocyanate + weight of polyol} \times 100 \qquad [ Expression 1 ]$$

From the viewpoint of easily improving the abrasion resistance property, easily securing the strength, not easily deteriorating, and the like, the blending amount of the polyisocyanate is preferably set so that a NCO index (isocyanate index) is 110 or more. The NCO index is more preferably 115 or more, further preferably 120 or more, 125 or more, and 130 or more. On the other hand, from the viewpoint of not becoming too hard, easy formation, and the like, the blending amount of the polyisocyanate is preferably set so that the NCO index is 250 or less. The NCO index is more preferably 200 or less, further preferably 180 or less. The NCO index is calculated as an equivalent weight of the isocyanate group with respect to a total equivalent weight of 100 of the active hydrogen groups (hydroxyl group, amino group, and the like) reacting with the isocyanate group.

The polyol used for forming the aqueous polyurethane resin may be a polyester polyol, a polyether polyol, a polycarbonate polyol, and the like. In particular, from the viewpoint of the abrasion resistance property and the like, a polycarbonate polyol is preferable.

A polyester polyol obtained from a polybasic organic acid and a low-molecular-weight polyol and taking a hydroxyl group as a terminal group can be exemplified as a suitable polyester polyol. By using the polyester polyol as the polyol for forming the polyurethane, the abrasion resistance property necessary for endurance can be secured. The polybasic organic acid is not particularly limited and may be: saturated fatty acids such as oxalic acid, succinic acid, glutaric acid, adipic acid, pimelic acid, suberic acid, azelaic acid, sebacic acid, and isosebacic acid; unsaturated fatty acids such as maleic acid and fumaric acid; dicarboxylic acids of aromatic acids or the like such as phthalic acid, isophthalic acid, and terephthalic acid; acid anhydrides such as maleic anhydride and phthalic anhydride; dialkyl esters such as dimethyl terephthalate; dimer acids obtained by dimerization of unsaturated fatty acids; and the like. The low-molecular-weight polyol used together with the polybasic organic acid is not particularly limited and may be, for example, diols such as ethylene glycol, diethylene glycol, triethylene glycol, propylene glycol, dipropylene glycol, butylene glycol, neopentyl glycol, and 1,6-hexylene glycol; triols such as trimethylolethane, trimethylolpropane, hexanetriol, and glycerin; hexaols such as sorbitol; and the like

Specifically, more suitable polyester polyol includes: polyethylene adipate (PEA), polybutylene adipate (PBA), polyhexylene adipate (PHA), copolymer of ethylene adipate and butylene adipate (PEA/BA), and the like. One type of these polyester polyols may be used alone, or two or more types may be used in combination. In particular, from the viewpoint of the improvement in abrasion resistance property, the improvement in durability, and the like, polybutylene adipate (PBA) is particularly preferable.

The number average molecular weight of the polyester polyol is preferably 1000 to 3000. A tan δ peak temperature and a tan δ peak value serving as indexes of the viscoelasticity of the urethane are adjusted, and the physicality security and the formability improvement are easily obtained. From this viewpoint, the number average molecular weight is more preferably 1500 to 2500.

The polyether polyol may be polypropylene glycol (PPG), polytetramethylene glycol (PTMG), ethylene oxide modified polyol of the two, polyethylene glycol (PEG), and the like. The average molecular weight (Mn) of the polyether polyol is preferably 1000 to 10000.

The polycarbonate polyol (polycarbonate diol) is obtained by using an alkylenediol as a monomer and polymerizing the alkylenediol with a low-molecular-weight carbonate compound. The alkylenediol serving as a monomer may be 1,6-hexanediol, 1,5-pentanediol, 1,4-butanediol, cyclohexanedimethanol, and the like. The alkylenediol serving as a monomer may be only one type or two or more types of the above alkylenediols.

The hydrophilic group-containing component used for forming the aqueous polyurethane resin may be a dialkylol alkanoic acid, an amine salt of dialkylol alkanoic acid, a sodium sulfonate-containing diol, a polyalkylenepolyol, and the like. The dialkylol alkanoic acid may be dimethylol propionic acid, dimethylol butanoic acid, dimethylol heptanoic acid, dimethylol octanoic acid, and the like. The amine of the amine salt may be triethylamine and the like.

(b) is a urethane curing agent. The urethane curing agent (b) is a curing agent that cures the aqueous polyurethane resin (a). The urethane curing agent is composed of a compound containing an isocyanate group. The urethane curing agent (b) is preferably a terminal isocyanate-modified polyurethane. The polyurethane of the terminal isocyanate-modified polyurethane is a reaction product of a polyisocyanate and a polyol. The polyisocyanate and the polyol used for forming the terminal isocyanate-modified polyurethane may be the compounds exemplified in the polyisocyanate and the polyol used for forming the aqueous polyurethane resin.

The terminal isocyanate-modified polyurethane preferably has an anionic hydrophilic group. When (b) is a terminal isocyanate-modified polyurethane and has an anionic hydrophilic group, the self-emulsifying power is high and (b) in the emulsion composition has excellent dispersion stability. The anionic hydrophilic group may be those exemplified in the above aqueous polyurethane resin.

The terminal isocyanate-modified polyurethane is preferably a blocked isocyanate group in which the terminal isocyanate group is blocked with a blocking agent. In the blocked isocyanate, the blocking agent is dissociated and the isocyanate is released at a temperature equal to or higher than a predetermined dissociation temperature. The released isocyanate is the isocyanate forming the blocked isocyanate. When the terminal isocyanate group is a blocked isocyanate group, the emulsion composition has excellent stability. In addition, in the emulsion composition, the curing of (a) caused by (b) can be slowed down. Then, when the emulsion composition contains (e) the fluorine-based surface modifier, it is possible to suppress the curing of (a) caused by (b) before (e) bleeds on the surface after application of the emulsion composition, and it is possible to contribute to sufficient performance of properties of (e).

From the viewpoint that the blocking agent does not dissociate and the activity of the isocyanate group is easily maintained before heating to a predetermined temperature before or during application, the blocked isocyanate preferably has a dissociation temperature of 100° C. or higher. More preferably, the dissociation temperature is 120° C. or higher. In addition, from the viewpoint that the heating temperature for dissociating the blocking agent during curing is easily kept low, the dissociation temperature is preferably 160° C. or lower. More preferably, the dissociation temperature is 140° C. or lower.

A compound having active hydrogen is used as the blocking agent forming the blocked isocyanate. The compound having active hydrogen may be oximes, pyrazoles, carbazoles, secondary amine, β-dicarbonyl compound, lactams, phenols, and the like. These compounds may be used alone as the blocking agent forming the blocked isocyanate, or two or more types of the compounds may be used in combination.

The oximes include aldoxime and ketoxime. The aldoxime includes formaldoxime, acetaldoxime, and the like. The ketoxime includes dimethyl ketoxime, methyl ethyl ketoxime, methyl isobutyl ketoxime, methyl amyl ketoxime, acetoxime, cyclohexanoneoxime, and the like. The pyrazoles include pyrazole, 3-methyl pyrazole, 3,5-dimethyl pyrazole, and the like. The carbazoles include carbazole. The secondary amine includes: dipropyl amine, diisopropyl amine, dibutyl amine, diisobutyl amine, di(tert-butyl) amine, ethyl propyl amine, ethyl isopropyl amine, ethyl butyl amine, ethyl isobutyl amine, ethyl (tert-butyl) amine, dicyclohexyl amine, N-methyl aniline, diphenyl amine, piperidine, 2-methyl piperidine, 2,6-dimethyl piperidine, 2,2,6,6-tetramethyl piperidine, and the like. The β-dicarbonyl compounds include: malonic diesters such as dimethyl malonate and diethyl malonate, acetoacetic esters such as methyl acetoacetate and ethyl acetoacetate, and the like. The lactams include ε-caprolactam and the like. The phenols include phenol and the like.

From the viewpoint that the stability of the blocked isocyanate is excellent and the dissociation temperature of the blocked isocyanate is suitable, the blocking agent is preferably methyl ethyl ketoxime, diisopropyl amine, phenol, ε-caprolactam, diethyl malonate, 3,5-dimethyl pyrazole, ethyl acetoacetate, and the like. In addition, from the viewpoint that the dissociation temperature of the blocked isocyanate tends to be relatively low, 3,5-dimethyl pyrazole and methyl ethyl ketoxime are preferable.

In the emulsion composition, the content of the urethane curing agent (b) is preferably in the range of 5 to 40 parts by mass with respect to 100 parts by mass of (a). The content is more preferably in the range of 10 to 30 parts by mass, further preferably in the range of 15 to 20 parts by mass.

The associative thickener (c) is a thickener taking a hydrophilic group as a skeleton and having hydrophobic groups at side chains or terminals. For the associative thickener (c), in an aqueous medium, one hydrophobic group is adsorbed by one hydrophobic group of another associative thickener or particles that are added, and the other hydrophobic group is absorbed by the other hydrophobic group of the another associative thickener or other particles that are added, thereby forming a crosslinked structure and obtaining a thickening effect accordingly. Therefore, the associative thickener (c) forms a crosslinked structure that crosslinks the carbon black (d).

In the associative thickener (c), the hydrophilic group may be a nonionic hydrophilic group or an ionic hydrophilic group (anionic hydrophilic group, cationic hydrophilic group). The associative thickener (c) is preferably a nonionic thickener having a hydrophobic group and a nonionic hydrophilic group. When (c) is a nonionic thickener having a hydrophobic group and a nonionic hydrophilic group, the electrostatic action of (c) is small, and thus the reduction in dispersibility of (d) in the emulsion composition caused by the electrostatic action of (c) is suppressed. In addition, when (a) or (b) has an anionic hydrophilic group, the gelation caused by the ionic interaction between (a) and (c) or the ionic interaction between (b) and (c) is suppressed.

The hydrophilic group of (c) may be the hydrophilic group exemplified in (a). The hydrophilic group of (c) is particularly preferably a nonionic polyoxyalkylene group. The hydrophobic group of (c) may be an alkyl group or a phenyl group. In particular, alkyl group is preferable. The alkyl group may have a linear chain, a branched chain, or a cyclic shape. The carbon number of the alkyl group is preferably in the range of 4 to 30. Among the alkyl groups, an alkyl group having a branched chain is particularly preferable from the viewpoint of dispersibility in water.

The associative thickener (c) is preferably a urethane-based associative thickener. That is, the associative thickener (c) is preferably an associative thickener having a skeleton of polyurethane. The polyol or polyisocyanate forming the polyurethane of the skeleton includes those exemplified in (a). Depending on the type of the polyol, the urethane-based associative thickener may be ester-based, ether-based, carbonate-based, and the like. In an ether-based associative thickener in which the polyol is polyether polyol, the polyether part of the polyether polyol is a hydrophilic group. As the urethane-based associative thickener, an ether-based associative thickener is particularly preferable. In addition, the polyisocyanate of the urethane-based associative thickener is preferably an aliphatic polyisocyanate (non-yellowing polyisocyanate) from the viewpoint of preventing coloration.

In the emulsion composition, the content of the associative thickener (c) is preferably in the range of 0.5 to 10 parts by mass with respect to 100 parts by mass of (a). The content is more preferably in the range of 1.0 to 8.0 parts by mass, further preferably in the range of 1.5 to 5.0 parts by mass.

The carbon black (d) is blended for conductivity of the surface layer. The carbon black (d) preferably has an anionic surface functional group. This surface functional group may be a carboxylate group (—COO—), a hydroxyl group (—OH), and the like. When (d) has an anionic surface functional group, (d) in the emulsion composition has excellent dispersion stability.

In the emulsion composition, the content of the carbon black (d) is preferably in the range of 5.0 to 50 parts by mass with respect to 100 parts by mass of (a). The content is more preferably in the range of 10 to 25 parts by mass.

The emulsion composition may contain a surface modifier in addition to the above (a) to (d) in a range not affecting the present disclosure. The surface modifier may be a silicone surface modifier or the fluorine-based surface modifier (e). In addition, silica particles (f) may be contained. In addition, roughness formation particles for forming surface roughness may be contained. In addition, additives may be contained. The additives include a conductive agent (ionic conductive agent, electronic conductive agent), a filler, a stabilizer, an ultraviolet absorber, a lubricant, a release agent, a dye, a pigment, a flame retardant, and the like.

The fluorine-based surface modifier (e) is composed of a compound having a fluorine-containing organic group (a compound having a fluorine-containing group). By appearing on the surface of the surface layer 16, the fluorine-based surface modifier (e) suppresses the adhesion of toner, an external toner additive and the like, and improves the antifouling property of the roller surface. Preferably, the fluorine-based surface modifier (e) further has a carboxy group and an amino group. When (e) has a carboxy group and an amino group, the resistance uniformity is improved.

The fluorine-based surface modifier (e) can be configured as an acrylic polymer. The acrylic polymer means a copolymer of (meth)acrylate, a copolymer of (meth)acrylamide, a copolymer of (meth)acrylate and (meth)acrylamide, and the like. For example, a surface modifier having a fluorine-containing organic group can be obtained by copolymerizing a (meth)acrylate having a fluorine-containing organic group and a (meth)acrylate having a fluorine-free organic group. In addition, a surface modifier having a fluorine-containing organic group, a carboxy group, and an amino group can be obtained by copolymerizing a (meth)acrylate having a fluorine-containing organic group, a (meth)acrylate having a fluorine-free organic group, a (meth)acrylate having a carboxy group, and a (meth)acrylate having an amino group.

The acrylic polymer may contain a copolymerizable non-modified (meth)acrylate or non-modified (meth)acrylamide as a copolymerization component. The non-modified (meth)acrylate may be alkyl (meth)acrylate, hydroxyalkyl (meth)acrylate, and the like. The alkyl (meth)acrylate may be methyl (meth)acrylate, ethyl (meth)acrylate, propyl (meth)acrylate, butyl (meth)acrylate, 2-ethylhexyl (meth)acrylate, and the like. The hydroxyalkyl (meth)acrylate may be hydroxyethyl (meth)acrylate, hydroxypropyl (meth)acrylate, hydroxybutyl (meth)acrylate, and the like. In particular, methyl (meth)acrylate is preferable from the viewpoint of copolymerization reactivity.

The copolymerizable non-modified (meth)acrylamide may be (meth)acrylamide, alkyl (meth)acrylamide, hydroxyalkyl (meth)acrylamide, and the like. The alkyl (meth)acrylamide may be methyl (meth)acrylamide, ethyl (meth)acrylamide, propyl (meth)acrylamide, butyl (meth)acrylamide, 2-ethylhexyl (meth)acrylamide, and the like. The hydroxyalkyl (meth)acrylamide may be hydroxyethyl (meth)acrylamide, hydroxypropyl (meth)acrylamide, hydroxybutyl (meth)acrylamide, and the like. In particular, methyl (meth)acrylamide is preferable from the viewpoint of copolymerization reactivity.

The fluorine-containing organic group may be a fluoroalkyl group having 1 to 20 carbon atoms. The fluoroalkyl group may be a perfluoroalkyl group in which all hydrogen atoms of the alkyl group are substituted with fluorine atoms, or a fluoroalkyl group in which some hydrogen atoms of the alkyl group are substituted with fluorine atoms. In particular, from the viewpoint of being easily unevenly distributed on the surface of the surface layer 16, the perfluoroalkyl group is preferable.

The fluoroalkyl group having 1 to 20 carbon atoms may be a trifluoromethyl group, a pentafluoroethyl group, a heptafluoropropyl group, a nonafluorobutyl group, a trifluoroethyl group, a pentafluoropropyl group, a heptafluorobutyl group, and the like.

The (meth)acrylate group having a fluorine-containing group and the (meth)acrylamide having a fluorine-containing group can be represented by, for example, the following general formula (1).

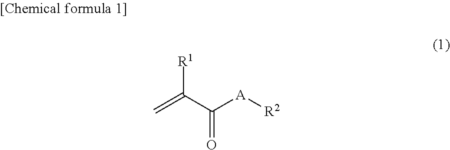

In Formula (1), A is O or NH, R¹ is hydrogen or a methyl group, and R² is a fluoroalkyl group having 1 to 20 carbon atoms.

The (meth)acrylate having a carboxy group may be (meth)acrylic acid and the like. The (meth)acrylate having an amino group may be dialkylaminoalkyl (meth)acrylate. The (meth)acrylamide having an amino group may be dialkylaminoalkyl (meth)acrylamide.

In the fluorine-based surface modifier (e), the content of the fluorine-containing group is preferably in the range of 0.01 to 60 mol % from the viewpoint that (e) tends to be unevenly distributed on the surface of the surface layer 16. The content is more preferably 0.05 to 50 mol % and further preferably 0.1 to 30 mol %. In addition, in the fluorine-based surface modifier having a carboxy group and an amino group, the content of the carboxy group and the amino group is preferably in the range of 0.01 to 60 mol %. The content is more preferably 0.05 to 50 mol % and further preferably 0.1 to 30 mol %. Each content can be measured by GC-MS analysis, NMR analysis or the like.

In the emulsion composition, the content of the fluorine-based surface modifier (e) is preferably in the range of 0.5 to 8.0 parts by mass with respect to 100 parts by mass of (a). The content is more preferably in the range of 1.0 to 5.0 parts by mass.

From the viewpoint of dispersibility in the emulsion composition, the silica particles (f) are preferably aqueous silica (water-dispersible silica). The aqueous silica (water dispersible silica) has a hydrophilic group on the surface, and the hydrophilic group may be a nonionic hydrophilic group or an ionic hydrophilic group (anionic hydrophilic group, cationic hydrophilic group). In particular, an ionic hydrophilic group is preferable, and an anionic hydrophilic group is particularly preferable. When the surface has an ionic hydrophilic group, the dispersibility is easily maintained due to the repulsion of surface charge.

The silica particles (f) are preferably (nano-sized) spherical silica having a diameter of 500 nm or less. When the silica particles (f) are (nano-sized) spherical silica having a diameter of 500 nm or less, the dispersibility in the emulsion composition is improved, and the resistance uniformity is improved. The diameter of the spherical silica is more preferably in the range of 30 to 420 nm. The diameter of the spherical silica can be represented by the average particle diameter obtained by the BET method (specific surface area measurement).

In the emulsion composition, the content of the silica particles (f) is preferably in the range of 5.0 to 50 parts by mass with respect to 100 parts by mass of (a). The content is more preferably in the range of 10 to 25 parts by mass.

The surface layer 16 can be formed by applying the emulsion composition, which is a material for forming the surface layer 16, to the outer peripheral surface of the elastic body layer 14 and performing heat treatment, crosslinking treatment, and the like if necessary.

In the conductive roller 10, the surface layer 16 is formed from the emulsion composition containing the above (a) to (d). The emulsion composition is a water-based coating. The water-based coating has a slower drying rate than the organic coating. Therefore, convection occurs in the liquid during formation of the surface layer 16, the frequency of collision between the carbon black increases, and aggregation easily occurs. When the carbon black is aggregated in the surface layer 16, the resistance uniformity of the surface layer 16 is deteriorated. The convection of the carbon black in the liquid can be suppressed by, for example, blending a thickener. On the other hand, it is necessary to prevent the thickener to be blended from exerting an influence on the dispersion mechanism of the carbon black in the water-based coating. In the emulsion composition, the thickener to be blended is an associative thickener so that the dispersion mechanism of the carbon black is not affected, and a thickening action is exerted, the agglomeration of the carbon black is suppressed during formation of the surface layer 16, and the resistance uniformity of the surface layer 16 is excellent. When the thickener to be blended is a non-associative thickener, the dispersion mechanism of the carbon black in the water-based coating is affected due to the interaction with the carbon black, and the aggregation of the carbon black is not sufficiently suppressed.

In addition, when the fluorine-based surface modifier (e) is blended, in order to sufficiently exert the function of (e), it is necessary to bleed (e) on the surface in the coating film of the emulsion composition. Therefore, in order to slow down the curing of (a) caused by (b), in the urethane curing agent (b), a blocked isocyanate group in which the terminal isocyanate group is blocked with a blocking agent is preferable. In this case, the curing reaction is slowed down and the carbon black (d) tends to aggregate. However, by using the associative thickener (c) according to the present disclosure, the aggregation of the carbon black (d) can be suppressed even in this case, and the uniform resistance can be satisfied.

The thickness of the surface layer 16 is not particularly limited and is preferably in the range of 0.1 to 50 μm, more preferably in the range of 0.1 to 30 μm, and further preferably in the range of 0.3 to 20 μm. The thickness of the surface layer 16 can be measured by observing the cross section using a laser microscope (for example, “VK-9510” manufactured by Keyence Corporation, or the like).

The surface layer 16 can be adjusted to have a predetermined volume resistivity. The volume resistivity of the surface layer 16 may be appropriately set in the range of 10⁷ to 10¹⁴ Ω·cm, 10⁸ to 10¹³ Ω·cm, 10⁹ to 10¹² Ω·cm, and the like. The volume resistivity can be measured according to JIS K6911.

The elastic body layer 14 contains a crosslinked rubber. The elastic body layer 14 is formed of a conductive rubber composition containing an uncrosslinked rubber. The crosslinked rubber is obtained by crosslinking an uncrosslinked rubber. The uncrosslinked rubber may be a polar rubber or a non-polar rubber.

The polar rubber is a rubber having a polar group, and the polar group may be a chloro group, a nitrile group, a carboxyl group, an epoxy group, and the like. Specifically, the polar rubber may be hydrin rubber, nitrile rubber (NBR), urethane rubber (U), acrylic rubber (copolymer of acrylic ester and 2-chloroethyl vinyl ether, ACM), chloroprene rubber (CR), epoxidized natural rubber (ENR), and the like. Among the polar rubbers, the hydrin rubber and the nitrile rubber (NBR) are more preferable from the viewpoint that the volume resistivity tends to be particularly low.

The hydrin rubber may be epichlorohydrin homopolymer (CO), epichlorohydrin-ethylene oxide dicopolymer (ECO), epichlorohydrin-allyl glycidyl ether dicopolymer (GCO), epichlorohydrin-ethylene oxide-allyl glycidyl ether terpolymer (GECO), and the like.

The urethane rubber includes a polyether type urethane rubber having ether bond within the molecule. The polyether type urethane rubber can be manufactured by the reaction between diisocyanate and polyether having hydroxyl groups at both terminals. The polyether is not particularly limited and may be polyethylene glycol, polypropylene glycol, and the like. The diisocyanate is not particularly limited and may be tolylene diisocyanate, diphenylmethane diisocyanate, and the like.

The non-polar rubber may be silicone rubber (Q), isoprene rubber (R), natural rubber (NR), styrene butadiene rubber (SBR), butadiene rubber (BR), and the like. Among the non-polar rubbers, the silicone rubber is more preferable from the viewpoint of having a low hardness and being resistant to deterioration (excellent elastic recovery).

The crosslinking agent may be a resin crosslinking agent, a sulfur crosslinking agent, a peroxide crosslinking agent, and a dechlorination crosslinking agent. These cross-linking agents may be used alone, or two or more types of the cross-linking agents may be used in combination.

The resin crosslinking agent may be conventionally known resin crosslinking agents such as a phenol resin, a urea resin, an amino resin, a guanamine resin, a xylene resin, an unsaturated polyester resin, a diallylphthalate resin, an epoxy resin, and a urethane resin.

The sulfur cross-linking agent may be conventionally known sulfur cross-linking agents such as powdered sulfur, precipitated sulfur, colloidal sulfur, surface-treated sulfur, insoluble sulfur, sulfur chloride, thiuram-based vulcanization accelerator, and polymer polysulfide.

The peroxide crosslinking agent may be conventionally known peroxide crosslinking agents such as peroxyketal, dialkylperoxide, peroxyester, ketone peroxide, peroxydicarbonate, diacylperoxide, and hydroperoxide.

The dechlorination cross-linking agent may be dithiocarbonate compounds. More specifically, the dechlorination cross-linking agent may be quinoxaline-2,3-dithiocarbonate, 6-methylquinoxaline-2,3-dithiocarbonate, 6-isopropylquinoxaline-2,3-dithiocarbonate, 5,8-dimethylquinoxaline-2,3-dithiocarbonate, and the like.

From the viewpoint of resistance to bleeding, the blending amount of the cross-linking agent with respect to 100 parts by mass of the uncrosslinked rubber is preferably in the range of 0.1 to 2 parts by mass, more preferably in the range of 0.3 to 1.8 parts by mass, further preferably in the range of 0.5 to 1.5 parts by mass.

When a dechlorination crosslinking agent is used as the crosslinking agent, a dechlorination crosslinking accelerator may be used in combination. The dechlorination crosslinking accelerator may be 1,8-diazabicyclo(5,4,0)undecene-7 (hereinafter abbreviated as DBU) or a weak acid salt of DBU. The dechlorination crosslinking accelerator may be used in the form of DBU, but preferably used in the form of the weak acid salt of DBU from the viewpoint of handling. The weak acid salt of DBU may be carbonate, stearate, 2-ethylhexylate, benzoate, salicylate, 3-hydroxy-2-naphthoic acid salt, phenol resin salt, 2-mercaptobenzothiazole salt, 2-mercaptobenzimidazole salt, and the like.

From the viewpoint of resistance to bleeding, the content of the dechlorination crosslinking accelerator with respect to 100 parts by mass of the uncrosslinked rubber is preferably in the range of 0.1 to 2 parts by mass, more preferably in the range of 0.3 to 1.8 parts by mass, further preferably in the range of 0.5 to 1.5 parts by mass.

In order to impart conductivity, a conventionally known conductive agent such as carbon black, graphite, c-TiO₂, c-ZnO, c-SnO₂ (c- means conductivity), and an ionic conductive agent (quaternary ammonium salt, borate, surfactant, and the like) can be appropriately added to the elastic body layer 14. In addition, various additives may be added if necessary. The additives may include a lubricant, a vulcanization accelerator, an antioxidant, a light stabilizer, a viscosity modifier, a processing aid, a flame retardant, a plasticizer, a foaming agent, a filler, a dispersant, a defoamer, a pigment, a release agent, and the like.

The elastic body layer 14 can be adjusted to a predetermined volume resistivity according to the type of the crosslinked rubber, the blending amount of the ionic conductive agent, the blending of the electronic conductive agent, and the like. The volume resistivity of the elastic body layer 14 may be appropriately set in the range of 10² to 10¹⁰ Ω·cm, 10³ to 10⁹ Ω·cm, 10⁴ to 10⁸ Ω·cm, and the like depending on the application and the like.

The thickness of the elastic body layer 14 is not particularly limited and may be appropriately set in the range of 0.1 to 10 mm depending on the application and the like.

The elastic body layer 14 can be manufactured, for example, as follows. First, the shaft body 12 is coaxially installed in the hollow portion of a roller molding die, and an uncrosslinked conductive rubber composition is injected and removed from the mold after heating and curing (crosslinking), or the uncrosslinked conductive rubber composition is extruded onto the surface of the shaft body 12, thereby forming the elastic body layer 14 on the outer periphery of the shaft body 12.

The shaft body 12 is not particularly limited as long as it has conductivity. Specifically, a core bar formed of a solid body or a hollow body made of a metal such as iron, stainless steel and aluminum can be exemplified. If necessary, the surface of the shaft body 12 may be coated with an adhesive, a primer, and the like. In other words, the elastic body layer 14 may be adhered to the shaft body 12 via an adhesive layer (primer layer). If necessary, the adhesive, the primer, and the like may be made conductive.

### EXAMPLE

Hereinafter, the present disclosure is described in detail with reference to Examples and Comparative Examples.

The formulation shown in Table 1 was diluted with water so that the solid content concentration was 15% by mass, to prepare an emulsion composition. The prepared emulsion composition was applied on a PET film of 150 mm×300 mm, air-dried for 30 minutes, and then subjected to a heat treatment at 150° C. for 30 minutes in a PH oven. The obtained coating film was peeled off from the PET film to obtain a coating film.

The volume resistivity (log Ω [digit]) at five optional sites of the obtained coating film was measured, and the maximum-minimum difference was evaluated as the resistance uniformity. The case in which the maximum-minimum difference is 0.05 digit or less was regarded as particularly good “⊚”; the case in which the maximum-minimum difference is 0.05 digit or more and 0.3 digit or less was regarded as good “∘”; and the case in which the maximum-minimum difference exceeds 0.3 digit was regarded as poor “×”.

The materials to be used are as follows.
Aqueous polyurethane resin <1>: solid content of “Adeka Bontaita HUX350” manufactured by ADEKA
Aqueous polyurethane resin <2>: solid content of “Super Flex 620” manufactured by DKS Co. Ltd.
Blocked urethane curing agent <1>: “Elastoron E-37” manufactured by DKS Co. Ltd.
Blocked urethane curing agent <2>: “Trixiene Aqua BI200” manufactured by Baxenden
Non-blocked urethane curing agent: Tosoh Aquanate 105
Associative thickener: “Adekanol UH-756VF” manufactured by ADEKA
Non-associative thickener: sodium alginate (“Kimica Algin I-8” manufactured by KIMICA)
Carbon black: “Aqua Black 162” manufactured by Tokai Carbon Co. Ltd.
Fluorine-based surface modifier <1>: synthetic product described below
Fluorine-based surface modifier <2>: “Aron GF-400” manufactured by Toagosei Co. Ltd.
Spherical silica: Nissan Chemical “Snowtex ST-30” (average particle size 12 nm)

(Synthesis of Fluorine-Based Surface Modifier <1>)

0.11 g (1.3 mmol) of methacrylic acid, 1.57 g (15.7 mmol) of methyl methacrylate, 5.61 g (13 mmol) of 2-(perfluorohexyl) ethyl acrylate (“R-1620” sold by Daikin Kasei), 11.92 g (70 mmol) of 2-(dimethylamino) methacrylamide, and 14.38 g of MIBK were put into a reaction flask of 100 mL, nitrogen bubbling was performed for 5 minutes while stirring, and then polymerization was performed for 7 hours at a temperature of the inner solution of 80° C. Then, 26.64 g of MIBK was put in to obtain a solution of the fluorine-based surface modifier having a fluorine-containing group, a carboxy group, and an amino group.

TABLE 1

| | | | | | | | | | | | Comparative | |
|---|---|---|---|---|---|---|---|---|---|---|---|---|
| | | Hydrophilic | Example | | | | | | | | Example | |
| | | group | 1 | 2 | 3 | 4 | 5 | 6 | 7 | 8 | 1 | 2 |
| a | Aqueous polyurethane | Anion | 100 | — | 100 | 100 | 100 | 100 | 100 | 100 | 100 | 100 |
| | resin <1> | | | | | | | | | | | |
| | Aqueous polyurethane | Cation | — | 100 | — | — | — | — | — | — | — | — |
| | resin <2> | | | | | | | | | | | |
| b | Blocked urethane curing | Anion | 10 | — | — | 10 | — | 10 | 10 | 10 | 10 | 10 |
| | agent <1> | | | | | | | | | | | |
| | Blocked urethane curing | Cation | — | 10 | — | — | — | — | — | — | — | — |
| | agent <2> | | | | | | | | | | | |
| | Non-blocked urethane | Nonion | — | — | 10 | — | 10 | — | — | — | — | — |
| | curing agent | | | | | | | | | | | |
| c | Associative thickener | Nonion | 3 | 3 | 3 | 3 | 3 | 3 | 3 | 3 | — | — |
| | Non-associative thickener | | — | — | — | — | — | — | — | — | 3 | — |
| | (sodium alginate) | | | | | | | | | | | |
| d | Carbon black | | 20 | 20 | 20 | 20 | 20 | 20 | 20 | 20 | 20 | 20 |
| e | Fluorine-based surface | | 3 | 3 | 3 | — | — | — | 3 | — | 3 | 3 |
| | modifier <1> F, NR₂, | | | | | | | | | | | |
| | COOH | | | | | | | | | | | |
| | Fluorine-based surface | | — | — | — | — | — | 3 | — | — | — | — |
| | modifier <2> F | | | | | | | | | | | |
| f | Spherical silica | | — | — | — | — | — | — | 15 | 15 | — | — |

| | | | | | | | | | | |
|---|---|---|---|---|---|---|---|---|---|---|
| Resistance uniformity | ⊚ | ○ | ○ | ○ | ○ | ○ | ⊚ | ⊚ | x | x |

In the comparative examples not containing an associative thickener in the emulsion composition containing an aqueous polyurethane resin, a urethane curing agent, and carbon black, the dispersibility of the carbon black after application and before curing is poor and the resistance uniformity is not satisfied. On the other hand, in the examples containing an associative thickener in the above emulsion composition, the dispersibility of the carbon black after application and before curing is excellent and the resistance uniformity is satisfied.

Then, as is clear from Examples 1 and 2, when the hydrophilic groups of the aqueous polyurethane resin and the urethane curing agent are anionic, the resistance uniformity is improved. In addition, as is clear from Examples 1, 4, and 6, when the fluorine-based surface modifier has a carboxy group and an amino group, the resistance uniformity is improved. In addition, as is clear from Examples 4 and 8, when the emulsion composition contains silica particles and the silica particles are spherical silica having a diameter of 500 nm or less, the resistance uniformity is improved.

The embodiment and examples of the present disclosure have been described above, but the present disclosure is not limited to the above embodiment and examples, and various modifications may be made without departing from the gist of the present disclosure.

What is claimed is:

1. A conductive roller for electrophotographic device, comprising:
a shaft body, an elastic body layer formed on an outer periphery of the shaft body, and a surface layer formed on an outer periphery of the elastic body layer;
wherein the surface layer is formed from an emulsion composition containing the following (a) to (d):
(a) an aqueous polyurethane resin,
(b) a urethane curing agent,
(c) an associative thickener, and
(d) carbon black.

2. The conductive roller for electrophotographic device according to claim 1, wherein the (a) has an anionic hydrophilic group.

3. The conductive roller for electrophotographic device according to claim 1, wherein the (b) is a terminal isocyanate-modified polyurethane and has an anionic hydrophilic group.

4. The conductive roller for electrophotographic device according to claim 1, wherein the (d) has an anionic surface functional group.

5. The conductive roller for electrophotographic device according to claim 1, wherein the (c) is a nonionic associative thickener having a hydrophobic group and a nonionic hydrophilic group.

6. The conductive device for electrophotographic device according to claim 3, wherein the terminal isocyanate group of the (b) is a blocked isocyanate group blocked with a blocking agent.

7. The electrophotographic device for electrophotographic device according to claim 2, wherein the anionic hydrophilic group is a carboxylate group, and the carboxylate group forms an amine salt.

8. The electrophotographic device for electrophotographic device according to claim 3, wherein the anionic hydrophilic group is a carboxylate group, and the carboxylate group forms an amine salt.

9. The conductive composition for electrophotographic device according to claim 1, wherein the emulsion composition further contains (e) a fluorine-based surface modifier.

10. The conductive roller for electrophotographic device according to claim 8, wherein the (e) has a carboxy group and an amino group.

11. The conductive roller for electrophotographic device according to claim 1, wherein the emulsion composition further contains (f) silica particles, and the (f) is spherical silica having a diameter of 500 nm or less.

12. A method of manufacturing a conductive roller for electrophotographic device comprising a shaft body, an elastic body layer formed on the outer periphery of the shaft body, and a surface layer formed on the outer periphery of the elastic body layer;
wherein the method comprises forming the surface layer using an emulsion composition containing the following (a) to (d):
(a) an aqueous polyurethane resin,
(b) a urethane curing agent,
(c) an associative thickener, and
(d) carbon black.
